(19) United States
(12) Patent Application Publication
(10) Pub. No.: US 2025/0034343 A1
(43) Pub. Date: Jan. 30, 2025

(54) CONTINUOUS BIAS PATTERN FABRIC

(71) Applicant: Textron Systems Corporation, Hunt Valley, MD (US)

(72) Inventors: Matthew Weis Perrone, Boston, MA (US); Wesley Aaron Chapkin, Rockville, MD (US); Michael Vincent Salvucci, Clinton, MA (US); Michael Robert Favaloro, Amesbury, MA (US); Andrew Scott Wallace, Wakefield, MA (US)

(21) Appl. No.: 18/784,377

(22) Filed: Jul. 25, 2024

Related U.S. Application Data
(60) Provisional application No. 63/529,416, filed on Jul. 28, 2023.

(51) Int. Cl. C08J 5/24; B29C 70/22; B29C 70/30; B29C 70/54; B29K 63/00; B29K 105/08; B29K 307/04; B29L 31/30; B32B 5/02; B32B 7/06; B32B 27/12; B32B 37/20; B32B 37/26; B32B 38/00; B32B 38/08; D03D 15/275; D04C 1/04

(52) U.S. Cl. CPC C08J 5/243; B29C 70/22; B29C 70/30; B29C 70/54; B32B 5/02; B32B 5/024; B32B 7/06; B32B 27/12; B32B 37/203; B32B 37/26; B32B 38/0004; B32B 38/08; D03D 15/275; D04C 1/04; B29C 2793/0081; B29K 2063/00; B29K 2105/0827; B29K 2105/0845; B29K 2105/089; B29K 2307/04; B29L 2031/30; B32B 2037/268; B32B 2260/021; B32B 2260/046; B32B 2262/106; B32B 2305/184; B32B 2305/188; B32B 2307/748; B32B 2313/04; B32B 2605/00; C08J 2363/00; D10B 2505/02

(57) ABSTRACT

Techniques are directed to providing a carbon composite product. Such techniques involve providing a bias pattern fabric that extends from a starting side along a run direction, the bias pattern fabric including carbon fiber threads oriented diagonally relative to the run direction. Such techniques further involve impregnating the bias pattern fabric with resinous material to form a run of prepreg material. Such techniques further involve cutting the run of prepreg material lengthwise to the run direction to form multiple tapes.

### CROSS REFERENCE TO RELATED APPLICATIONS

This application is a regular utility application based on earlier-filed U.S. Application No. 63/529,416 filed on Jul. 28, 2023, entitled “Continuous Bias Pattern Fabric”, the contents and teachings of which are hereby incorporated by reference in their entirety.

### BACKGROUND

A conventional approach to forming a reel of ±45° prepreg initially involves weaving carbon fibers into a 0°/90° woven carbon fiber sheet and applying resin to the 0°/90° woven carbon fiber sheet to form 0°/90° prepreg 100. As shown in FIG. 1, the 0°/90° prepreg 100 has two outer edges 102 parallel to the X-axis. Additionally, the 0°/90° prepreg 100 has carbon fibers 110 extending lengthwise along the X-axis (i.e., 0° fibers along the X-axis) and other carbon fibers 120 extending perpendicularly from the outer edges 102 along the Y-axis (i.e., 90° fibers).

Multiple cuts 130 are then made to the 0°/90° prepreg 100 at a 45° angle to the outer edges 102 to form separate ±45° plies 140. As shown in FIG. 2, the ends 200 of the ±45° plies 140 are then stitched together to form a longer and longer section of ±45° prepreg which is then wound to form the reel. For example, if the 0°/90° prepreg 100 (FIG. 1) is 50 inches wide from edge 102 to edge 102, the 0°/90° prepreg 100 can be cut at a 45° angle for form multiple four to six foot long ±45° plies 140 which can be stitched together to form a longer section of ±45° prepreg for the reel.

### SUMMARY

It should be understood that there are deficiencies to the above-described conventional approach to forming a reel of ±45° prepreg. For example, certain aerospace applications form ablative composites for heat shielding from ±45° prepreg. During ablation, material is lost (or sacrificed) while dissipating large amounts of heat. Unfortunately, the stitching between ±45° plies is considered a contaminant and may cause the composite to behave in an undesired manner (e.g., fracture or tear in a particular direction rather than absorb stress, etc.). Accordingly, the numerous stitches make the ±45° prepreg impractical or at least poorly suited for certain applications and processing utilized to manufacture composite parts.

Moreover, it should be understood that the ends 200 of the ±45° plies 140 (e.g., see FIG. 2) are not perpendicular to the edges of the ±45° plies 140, but are instead at a diagonal to the edges 210 of the ±45° plies 140. Accordingly, if the ends 200 of the ±45° plies are simply stitched together, the stitched areas are relatively long and thus more prone to causing undesirable effects. However, if the ends 200 of the ±45° plies 140 are trimmed to be perpendicular to the edges 210, the stitches may be shorter but more waste is created.

In contrast to the above-described conventional approach, improved techniques are directed to providing a carbon composite product from a continuous bias pattern fabric. Along these lines, such techniques involve creating significantly long runs of bias pattern fabric to create significantly long runs of bias prepreg. The bias prepreg is then cut in the direction of the run (e.g., continuously sliced) to form long bias tapes. Accordingly, such techniques enable production of long runs of bias tape with relative few seams. Moreover, such seams may already be perpendicular to the tape edges resulting in shorter seams, less waste, and better uniformity.

One embodiment is directed to a method of providing a carbon composite product. The method includes providing a bias pattern fabric that extends from a starting side along a run direction, the bias pattern fabric including carbon fiber threads oriented diagonally relative to the run direction. The method further includes impregnating the bias pattern fabric with resinous material to form a run of prepreg material. The method further includes cutting the run of prepreg material lengthwise to the run direction to form multiple tapes.

Another embodiment is directed to a carbon composite product formed by a method which includes:
(A) providing a bias pattern fabric that extends from a starting side along a run direction, the bias pattern fabric including carbon fiber threads oriented diagonally relative to the run direction;
(B) impregnating the bias pattern fabric with resinous material to form a run of prepreg material; and
(C) cutting the run of prepreg material lengthwise to the run direction to form multiple tapes which are placed onto a set of tools to form at least a portion of the carbon composite product.

Yet another embodiment is directed to a vehicle (or other equipment) having a vehicle body constructed and arranged to carry a payload. The vehicle further includes a carbon composite product coupled with the vehicle body. The carbon composite product is formed by a method comprising:
(A) providing a bias pattern fabric that extends from a starting side along a run direction, the bias pattern fabric including carbon fiber threads oriented diagonally relative to the run direction,
(B) impregnating the bias pattern fabric with resinous material to form a run of prepreg material, and
(C) cutting the run of prepreg material lengthwise to the run direction to form multiple tapes which are placed onto a set of tools to form at least a portion of the carbon composite product.

In some arrangements, providing the bias pattern fabric includes weaving a set of carbon fiber threads from a set of carbon fiber thread sources into the bias pattern fabric.

In some arrangements, weaving the set of carbon fiber threads includes:
(i) braiding the carbon fiber threads from the set of carbon fiber thread sources into a woven material tube,
(ii) cutting the woven material tube lengthwise to form a woven material run, and
(iii) laying the woven material run flat to provide the bias pattern fabric.

In some arrangements, braiding the carbon fiber threads includes generating a continuous run of woven carbon fiber threads that extends for at least 50 feet.

In some arrangements, impregnating the bias pattern fabric with resinous material includes provisioning the bias pattern fabric with a predefined resin content to form the run of prepreg material.

In some arrangements, provisioning the bias pattern fabric with the predefined resin content includes infusing resin into gaps between the carbon fiber threads and coating resin over the carbon fiber threads.

In some arrangements, infusing the resin into the gaps between the carbon fiber threads and coating resin over the carbon fiber threads includes:
(i) placing a set of resin films containing the resinous material in contact with the bias pattern fabric, and
(ii) applying pressure to the set of resin films to press the resinous material into the bias pattern fabric to form the run of prepreg material.

In some arrangements, infusing the resin into the gaps between the carbon fiber threads and coating resin over the carbon fiber threads includes running the bias pattern fabric through a resin bath, a series of rollers and a set of chambers under temperature and humidity control to form the run of prepreg material.

In some arrangements, infusing the resin into the gaps between the carbon fiber threads and coating resin over the carbon fiber threads includes passing the bias pattern fabric through a knife-over-roll coating process to form the run of prepreg material.

In some arrangements, the method further includes, after the bias pattern fabric is impregnated with the resinous material to form the run of prepreg material, applying a releasable film onto at least one side of the run of prepreg material to form a laminated prepreg carbon fabric.

In some arrangements, the method further includes rolling the laminated prepreg carbon fabric around a set of spools, the releasable film preventing layers of the laminated prepreg carbon fabric from sticking together while the laminated prepreg carbon fabric is rolled around the set of spools.

In some arrangements, the laminated prepreg carbon fabric has a first edge and a second edge which are parallel to the run direction. Additionally, cutting the run of prepreg material lengthwise includes prior to rolling the laminated prepreg carbon fabric around the set of spools, passing the laminated prepreg carbon fabric through a set of blades constructed and arranged to cut the laminated prepreg carbon fabric along a direction that is parallel to the first and second edges to form the multiple tapes.

In some arrangements, the laminated prepreg carbon fabric has a first edge and a second edge which are parallel to the run direction. Additionally, cutting the run of prepreg material lengthwise includes:
(i) after rolling the laminated prepreg carbon fabric around the set of spools, unrolling the laminated prepreg carbon fabric from the set of spools, and
(ii) passing the unrolled laminated prepreg carbon fabric through a set of blades constructed and arranged to cut the unrolled laminated prepreg carbon fabric along a direction that is parallel to the first and second edges to form the multiple tapes.

In some arrangements, the method further includes, prior to applying the releasable film, sewing the run of prepreg material to another run of prepreg material along a direction that is perpendicular to the run direction to form an aggregate run of prepreg material having a single seam over a length of at least 80 feet.

In some arrangements, the method further includes rolling the multiple tapes around spools to form bias tape rolls.

In some arrangements, the method further includes unrolling the multiple tapes from the spools, and placing the unrolled multiple tapes onto a set of tools to form a set of carbon composite structures.

In some arrangements, the method further includes, prior to placing the unrolled multiple tapes onto the set of tools, sewing a first tape to a second tape along a direction that is perpendicular to the run direction to form an aggregate tape having a single seam over a length of at least 80 feet.

In some arrangements, the method further includes, prior to placing the unrolled multiple tapes onto the set of tools, removing a releasable film from unrolled multiple tapes, the releasable film having been earlier applied to prevent layers of tape from sticking together.

Other embodiments are directed to systems, subsystems, assemblies, apparatus, specialized equipment, componentry, and so on. Some embodiments are directed to various methods, circuitry, devices, etc. which are involved in providing a carbon composite product from a continuous bias pattern fabric.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a view of a conventional approach which involves initially creating a 0°/90° prepreg sheet and then cutting the 0°/90° prepreg sheet at a 45° angle into short ±45° prepreg plies having 45° ends.

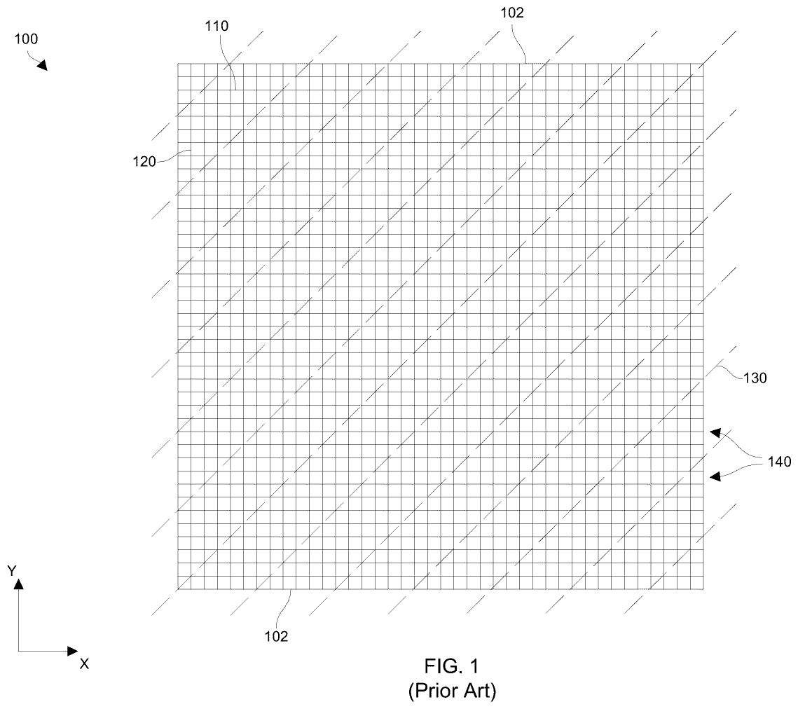

FIG. 2 is a view of a conventional approach to stitching together the short ±45° prepreg plies having the 45° ends.

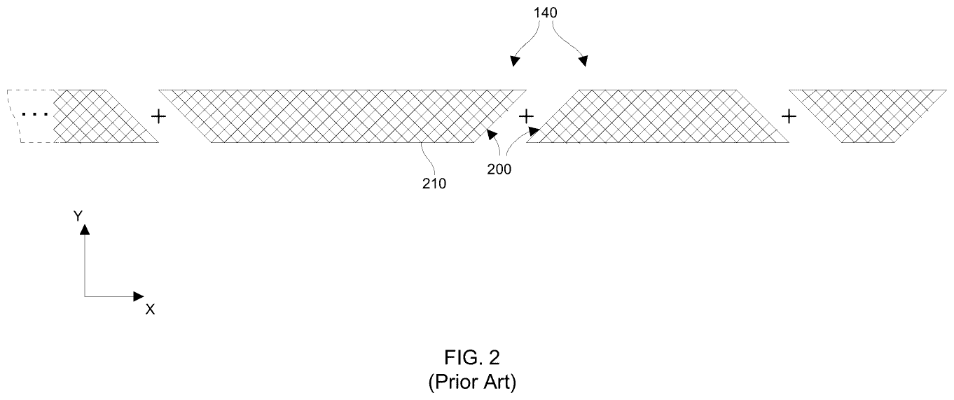

FIG. 3 is a view of equipment for providing a carbon composite product from a continuous bias pattern fabric in accordance with certain embodiments.

FIG. 4 is a view of initially creating an elongated run of ±45° prepreg material and cutting the elongated run of ±45° prepreg material into long ±45° prepreg segments having 90° ends in accordance with certain embodiments.

FIG. 5 is a view of stitching together the long ±45° prepreg segments having 90° ends in accordance with certain embodiments.

FIG. 6 is a perspective view of a first example process for impregnating a bias pattern fabric with resinous material to form a run of prepreg material in accordance with certain embodiments.

FIG. 7 is a perspective view of a second example process for impregnating a bias pattern fabric with resinous material to form a run of prepreg material in accordance with certain embodiments.

FIG. 8 is a perspective view of a third example process for impregnating a bias pattern fabric with resinous material to form a run of prepreg material in accordance with certain embodiments.

FIG. 9 is a perspective view of a process for forming elongated tapes of ±45° prepreg material in accordance with certain embodiments.

FIG. 10 is a flowchart of a procedure which is performed by specialized equipment to provide a carbon composite product in accordance with certain embodiments.

### DETAILED DESCRIPTION

An improved technique is directed to providing a carbon composite product from a continuous bias pattern fabric. Along these lines, such a technique involves creating a long run of bias pattern fabric in which carbon fibers are oriented diagonally (e.g., at a 45° angle) to the run to create a long run of bias prepreg. The bias prepreg is then cut in the direction of the run (e.g., continuously sliced) to form long bias tapes. Accordingly, such techniques enable production of relatively long runs of bias tape with relative few seams. Moreover, such seams may already be perpendicular to the tape edges resulting in shorter seams, less waste, and better uniformity.

It should be appreciated that such a technique is well-suited for use with carbon-fiber reinforced phenolic, as well as silica-fiber reinforced phenolic materials. Additionally, such a technique may be utilized with other materials, though the application/end use (ablation) may change.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

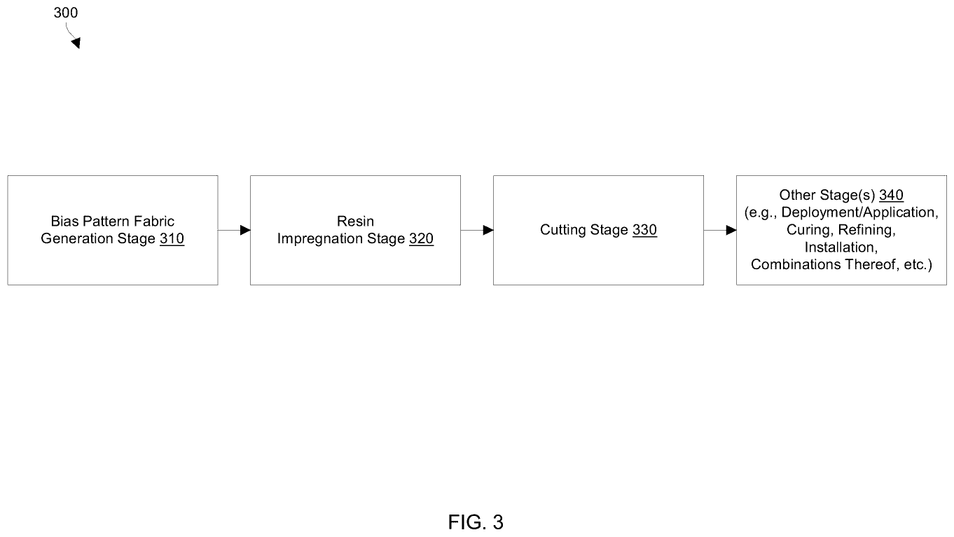

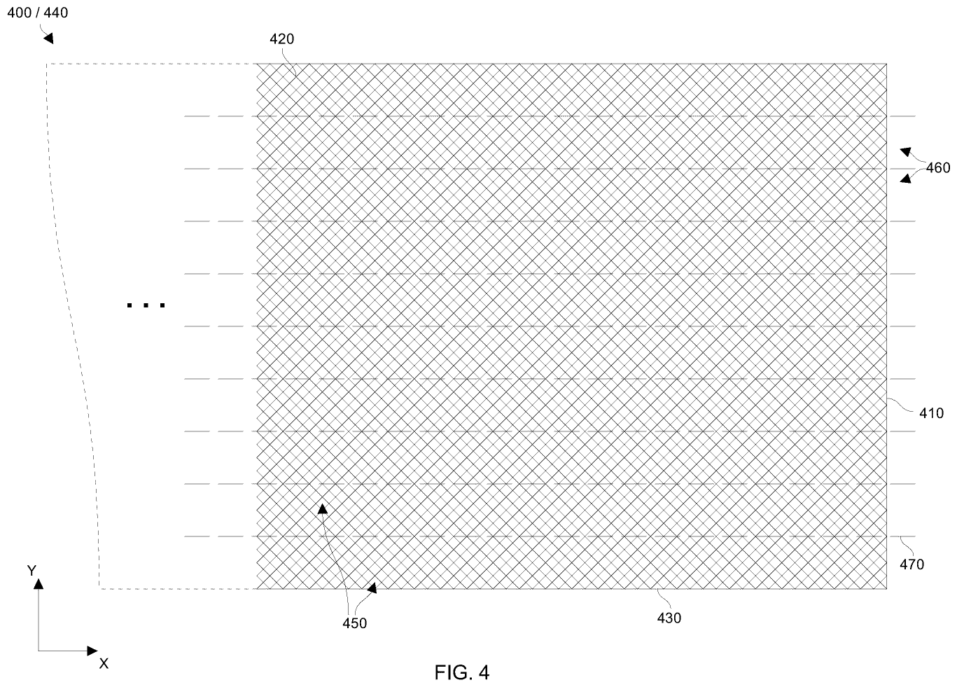

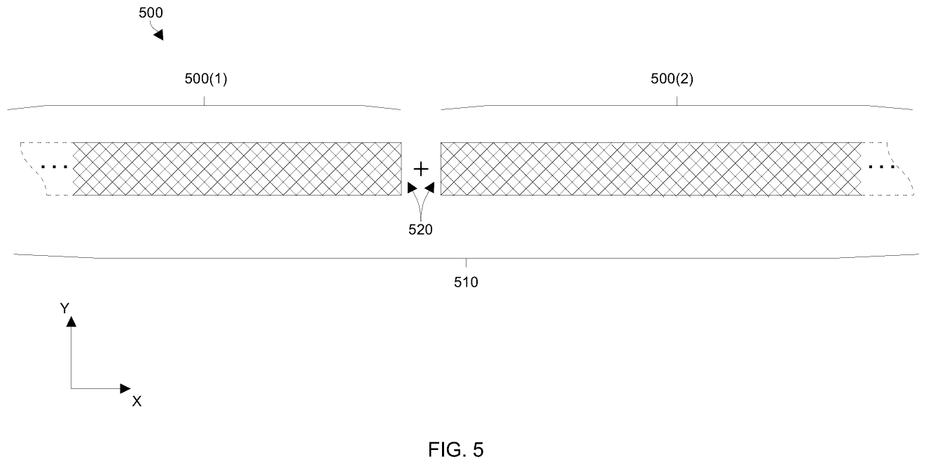

FIGS. 3 through 5 show certain details for providing a carbon composite product in accordance with certain embodiments. FIG. 3 shows a view of certain equipment 300 involved in providing the carbon composite product. FIG. 4 shows a view of the how carbon fibers of the produced prepreg material are already in a bias pattern prior to cutting. FIG. 5 shows a view of how lengths (or runs) of the prepreg material having naturally perpendicular ends are combined to form even longer lengths having perpendicular seams.

As shown in FIG. 3, the equipment 300 includes various stages arranged in a pipelined manner. Along these lines, the equipment 300 includes a bias pattern fabric generation stage 310, a resin impregnation stage 320, a cutting stage 330, and one or more other stages 340.

As shown in FIG. 4, the bias pattern fabric generation stage 310 is constructed and arranged to provide a bias pattern fabric 400 that extends in an elongated manner from a starting side 410 along a run direction (e.g., the positive X-direction in FIG. 4). The bias pattern fabric 400 includes carbon fiber threads 420 oriented diagonally relative to the run direction and the edges 430 of the bias pattern fabric 400 (e.g., at a 45 degree angle to the X and Y axes in FIG. 4).

Along these lines, the bias pattern fabric generation stage 310 (FIG. 3) may include assemblies similar to those used in the textile industry at a commercial level except that such assemblies handle carbon fiber threads 420. That is, the bias pattern fabric generation stage 310 weaves a set of carbon fiber threads 420 from a set of carbon fiber thread sources (e.g., thread spools) into the bias pattern fabric 400.

In some arrangements, the bias pattern fabric generation stage 310 (FIG. 3) initially braids the carbon fiber threads 420 from the set of carbon fiber thread sources into a woven material tube. Next, the bias pattern fabric generation stage 310 cuts the woven material tube lengthwise to form a woven material run. Then, bias pattern fabric generation stage 310 lays the woven material run flat to provide the bias pattern fabric 400.

It should be appreciated that the ellipsis (“ . . . ”) in FIG. 4 is intended to illustrate that the bias pattern fabric 400 may be provided for an extremely long length. Along these lines, while the side 410 may be a certain reasonable width (e.g., 12 feet, 10 feet, six feet, etc.), the bias pattern fabric 400 may be a run of at least 50 feet.

The resin impregnation stage 320 (FIG. 3) is constructed and arranged to impregnate the bias pattern fabric 400 with resinous material to form an elongated run of prepreg material 440. Along these lines, the resin impregnation stage 320 provisions the bias pattern fabric 400 with a predefined resin content by infusing resin into gaps 450 between the carbon fiber threads 420 and coating resin over the carbon fiber threads 420.

The cutting stage 330 (FIG. 3) is constructed and arranged to cut the run of prepreg material 440 lengthwise to the run direction (along the X-direction in FIG. 4) to form multiple tapes 460. As shown by the dashed lines 470 in FIG. 4, the cuts occur at 45 degrees to the orientation of the carbon fiber threads 420. Such tapes 460 then may be wound onto spools and therefore are themselves considered a carbon composite product. Alternatively, such tapes 460 are suitable for immediate subsequent use.

The other stages 340 (FIG. 3) refer to further use of the tapes 460 in one or more downstream activities (or applications). Examples of such uses include laying or layering the tapes 460 onto structures to provide heat protection, deployment over a tools to form a particularly shaped a heatshield, and so on. Accordingly, the tapes 460 may be applied, cured, refined (e.g., trimmed/further cut, sanded, etc.), bonded, treated, installed onto equipment/vehicles/devices/etc. combinations thereof, and so on.

As shown in FIG. 5, lengths 500(1), 500(2), . . . (collectively, lengths 500) of the prepreg material 440 are combined (e.g., sewn together) to form an even longer aggregate length 510 of the prepreg material 440. As further shown in FIG. 5, the ends 520 that are joined are perpendicular to the direction of the lengths 500 (e.g., the ends 520 are along the Y-axis). With the perpendicular seams, there is shorter stitching, less waste, and improved uniformity.

In some arrangements, the lengths 500 are unspooled (or unrolled) before the lengths 500 are combined. Along these lines, the lengths 500 may have been wound onto spools after cutting and later unwound to be joined together.

It should be understood that move than two lengths 500 may be combined end to end to form an extremely long aggregate length of prepreg material 510 if desired. In some arrangements, the aggregate length of prepreg material 510 has a single seam over a length of at least 80 feet.

It should be understood that the aggregate length 510 may be formed by combining separate tapes 460 (also see FIG. 4). That is, in some embodiments, the aggregate length 510 is formed by individual tapes 460 fastened together.

Alternatively, the aggregate length 510 may be formed by combining separate elongated whole runs of prepreg material 440 which are later cut after being joined together (also see FIG. 4). That is, in some embodiments, the aggregate length 510 is formed by individual runs of prepreg material 440 fastened together.

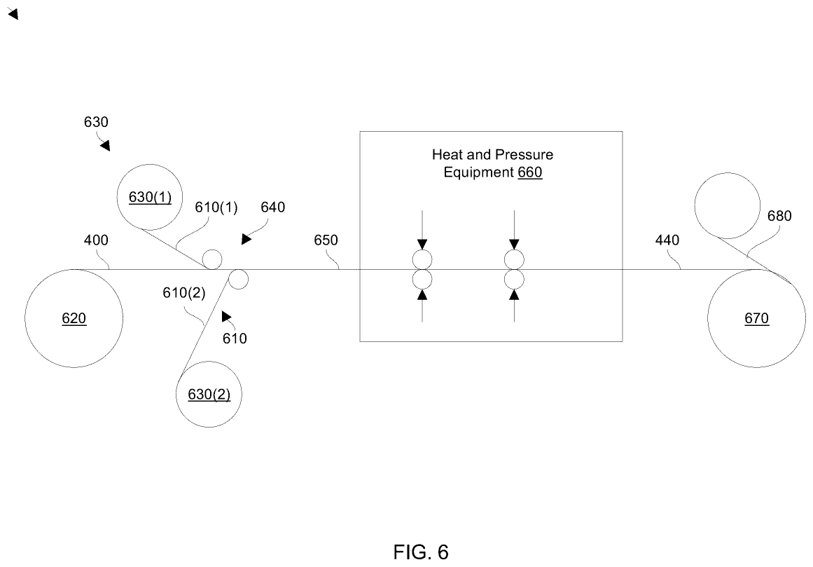

In some arrangements, the aggregate length 510 is immediately used (e.g., consumed by one or more of the other stages 340 (FIG. 3). In other arrangements, the aggregate length 510 is stored for later use (e.g., rolled onto a spool and housed in a controlled environment). Further details will now be provided with reference to FIGS. 6 through 8.

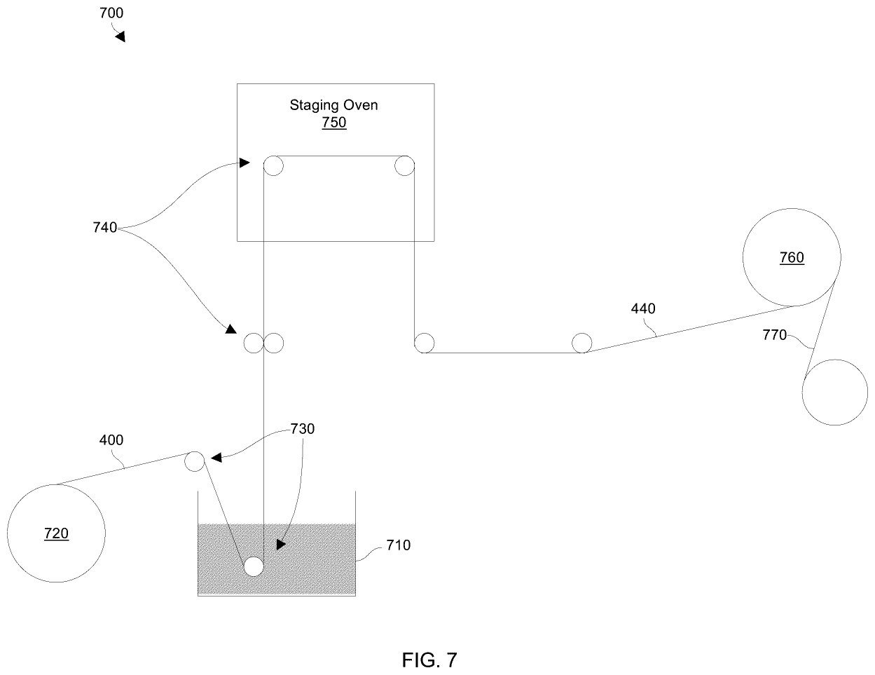

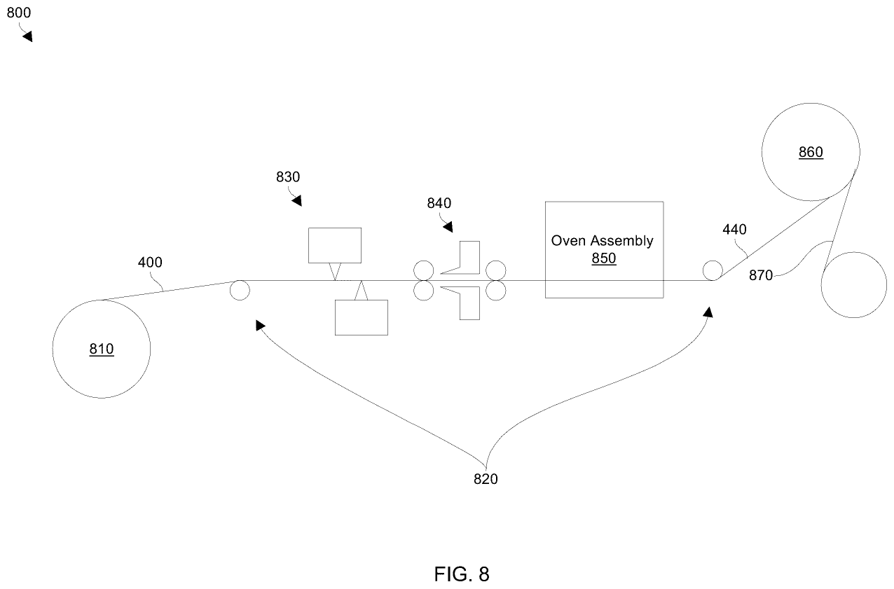

FIGS. 6 through 8 show a variety of methodologies which are suitable for performing such impregnation in accordance with certain embodiments. FIG. 6 shows a process for infusing resin layers into the bias pattern fabric 400 under pressure. FIG. 7 shows a process for immersing the bias pattern fabric 400 in a resin bath. FIG. 8 shows a process for performing knife-and-roll treatment for resin impregnation.

As shown in FIG. 6 and in accordance with certain embodiments, the resin impregnation stage 320 (FIG. 3) includes equipment 600 for infusing resin from a set of resin films 610(1), 610(2) (collectively, resin films 610) into the bias pattern fabric 400 under pressure. Recall that the bias pattern fabric 400 is provided by the bias pattern fabric generation stage 310 (also see FIG. 3).

By way of example, the bias pattern fabric 400 is de-spooled (or unrolled) from a spool 620 (e.g., the bias pattern fabric generation stage 310 outputs spools 620 of the bias pattern fabric 400 which are later unwound for input to the resin impregnation stage 320, also see FIG. 3). In other situations, the bias pattern fabric 400 is directly output from the bias pattern fabric generation stage 310 for input to the resin impregnation stage 320 without being rolled onto spools 620. In yet other situations, runs of the bias pattern fabric 400 are sewn together prior to resin impregnation to ultimately provide even longer runs of prepreg material 440.

During input (e.g., de-spooling of the bias pattern fabric 400), the set of resin films 610 is provided from a set of respective resin film sources 630(1), 630(2) (collectively, film sources 630). A preliminary set of rollers 640 then places the set of resin films 610 containing the resinous material in contact with the bias pattern fabric 400 (e.g., the set of rollers 640 provide proper alignment/registration as the resin films 610 make initial contact with the bias pattern fabric 400 to form a compound run 650.

The compound run 650 run then passes through heat and pressure equipment 660 which applies heat and pressure to the set of resin films 610 of the compound run 650 to press the resinous material of the set of resin films 610 into the bias pattern fabric 400 to form the run of prepreg material 440 (also see FIG. 4). In some arrangements, heating initiates at least partial curing of the resin. By way of example, the run of prepreg material 440 is then rolled onto a spool 670 for later use.

In some arrangements, the equipment 600 adds a lamination 680 (e.g., a releasable film) to the run of prepreg material 440 before spooling. Such lamination 680 prevents different layers of the prepreg material 440 from sticking and/or reacting with each other as the run of prepreg material 440 is wound.

As shown in FIG. 7 and in accordance with certain embodiments, the resin impregnation stage 320 (FIG. 3) includes equipment 700 for immersing the bias pattern fabric 400 in a resin bath 710. Again, recall that the bias pattern fabric 400 is provided by the bias pattern fabric generation stage 310 (also see FIG. 3).

By way of example, the bias pattern fabric 400 is de-spooled (or unrolled) from a spool 720 (e.g., the bias pattern fabric generation stage 310 outputs spools 720 of the bias pattern fabric 400). In other situations, the bias pattern fabric 400 is directly output from the bias pattern fabric generation stage 310 without being rolled onto spools 720. In yet other situations, runs of the bias pattern fabric 400 are sewn together prior to resin impregnation to eventually provide even longer runs of prepreg material 440.

During input of the bias pattern fabric 400, a set of rollers (or guides) 730 directs the bias pattern fabric 400 through the resin bath 710 while maintaining consistent tension. Another set of rollers 740 then provides further treatment as the run of prepreg material 440 exits the resin bath 710. Along these lines, the set of rollers 740 presses the resin into the bias pattern fabric 400, removes excess resin, keeps the run of prepreg material 440 under tension for further processing (e.g., rolling), etc.

Additionally, the run of prepreg material 440 passes through a staging oven 750 which initiates at least partial curing of the resin. Along these lines, the resinous material within the bath 710 may have less viscosity than other resin infusion techniques such as adding layers of higher viscosity resin from films, and curing aids in stabilizing the newly formed run of prepreg material 440.

By way of example, the run of prepreg material 440 is then rolled onto a spool 760 for later use. Again, in some arrangements, the equipment 700 adds a lamination 770 (e.g., a releasable film) to the run of prepreg material 440 before spooling.

As shown in FIG. 8 and in accordance with certain embodiments, the resin impregnation stage 320 (FIG. 3) includes equipment 800 for passing the bias pattern fabric through a knife-over-roll coating process to form the run of prepreg material 440. Again, recall that the bias pattern fabric 400 is provided by the bias pattern fabric generation stage 310 (also see FIG. 3).

By way of example, the bias pattern fabric 400 is de-spooled (or unrolled) from a spool 810 (e.g., the bias pattern fabric generation stage 310 outputs spools 810 of the bias pattern fabric 400). In other situations, the bias pattern fabric 400 is directly output from the bias pattern fabric generation stage 310 without being rolled onto spools 810. In yet other situations, runs of the bias pattern fabric 400 are sewn together prior to resin impregnation to eventually provide even longer runs of prepreg material 440.

As the inputted bias pattern fabric 400 continues through the knife-over-roll coating process, a set of rollers (or guides) 820 maintain proper feeding, alignment, and tension. Although only two rollers 820 are shown in FIG. 8, it should be understood that other numbers of rollers 820 are suitable for use.

As further shown in FIG. 8, a set of resin applicators 830 apply resin to the bias pattern fabric 400. In some arrangements, the set of resin applicators 830 applies resin to both sides of the run of bias pattern fabric 400 as the run of bias pattern fabric 400 passes by the set of resin applicators 830.

After the resin is applied to the run of bias pattern fabric 400, a set of knives (or scrapers) 840 remove excess resin leaving a precise amount of resin over the bias pattern fabric 400. In some embodiments, the set of knives 840 provides a predefined resin thickness to the bias pattern fabric 400 to form the run of prepreg material 440. In some arrangements, the run of prepreg material 440 passes through an oven assembly 850 (e.g., an oven with rollers, etc.) which initiates at least partial curing of the resin after run of prepreg material 440 exits the set of knives 840.

By way of example, the run of prepreg material 440 is then rolled onto a spool 860 for later use. Again, in some arrangements, the equipment 800 adds a lamination 870 (e.g., a releasable film) to the run of prepreg material 440 before spooling.

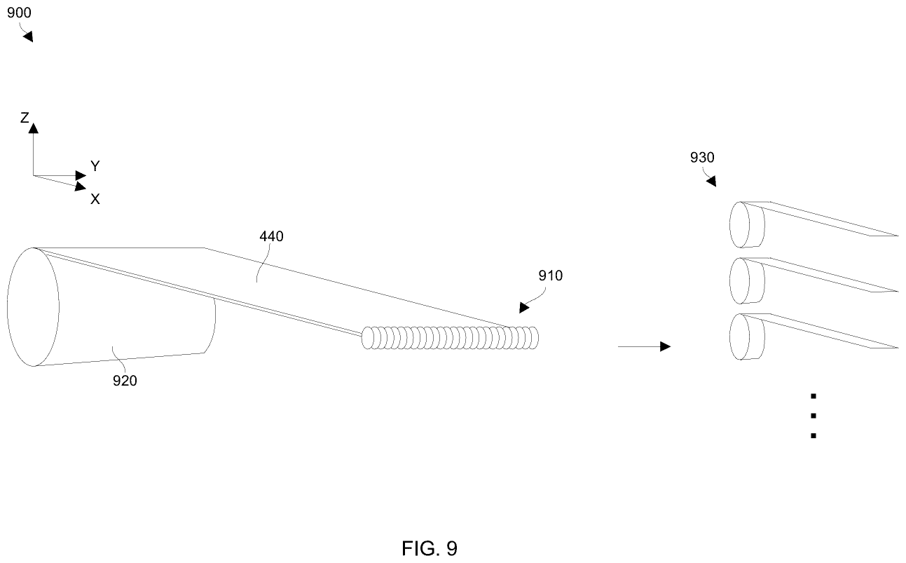

It should be understood that the various resin impregnation techniques discussed above in connection with FIGS. 6 through 8 may be modified, combination, etc. For example, knife-over-roll technologies may be incorporated into the equipment 600 and/or the equipment 700, and so on. Further details will now be provided with reference to FIG. 9.

FIG. 9 is a perspective view of a cutting process 900 for cutting a run of prepreg material 440 lengthwise to the run direction in accordance with certain embodiments. Such a process 900 may be performed by the earlier-mentioned cutting stage 330 of the equipment 300 when providing a carbon composite product (also see FIG. 3).

As shown in FIG. 9, the run of prepreg material 440 is moved in the positive X-direction toward a blade assembly 910. In some arrangements, the run of prepreg material 440 is unrolled from a spool 920 which rotates about the Y-axis (also see how the run of prepreg material 440 may be rolled up and stored in FIGS. 6 through 8).

The blade assembly 910 may include a series (or array) of blades (or cutters) spaced evenly apart to cut the run of prepreg material 440 into individual tapes 930 of uniform thickness. In some situations, the series of blades cuts the run of prepreg material 440 from both the top and bottom sides. In some situations, other cutting technologies are employed (e.g., laser cutting, saw cutting, combinations thereof, etc.). At this point, the individual tapes 930 may be used/consumed to make a set of carbon composite products or rolled up onto thinner spools for storage.

It should be understood that, in accordance with certain embodiments, the resin within the individual tapes 930 is at most partially cured. Accordingly, the tapes 930 can be applied, molded, shaped, adjusted, etc. and later fully cured to provide rich and reliable adhesion, contours, shapes, etc.

In some arrangements such as when the individual tapes 930 are immediately used/consumed after cutting, a laminate layer (e.g., a releasable film) which keeps the layers of prepreg material 440 from sticking to each other is removed from the run of prepreg material 440 during unrolling. For example, the individual tapes 930 may be fed to respective robotic assemblies that wrap the tapes 930 onto respective tools.

In some arrangements such as when the individual tapes 930 are to be stored, a laminate layer (e.g., a releasable film) which keeps the layers of prepreg material 440 from sticking to each other may be left on the run of prepreg material 440 during unrolling so that the laminate layer is cut by the blade assembly 910 and remains attached to the tapes 930. Accordingly, during tape rolling, there is no need to add a laminated layer (or film) to the tapes 930.

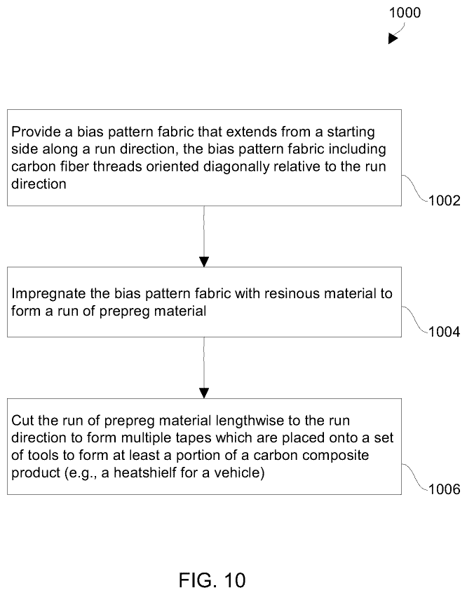

Alternatively, the laminate layer may be removed from the run of prepreg material 440 during unrolling, and new thinner laminate layers (e.g., releasable films) may be added to the individual tapes 930 during tape rolling. Such an alternative alleviates possible laminate layer interference during cutting. Further details will now be provided with reference to FIG. 10.

FIG. 10 is a flowchart of a procedure 1000 which is performed by specialized equipment to provide a carbon composite product in accordance with certain embodiments. The carbon composite product may be formed by relatively long runs of bias pattern carbon fiber tape with relatively few perpendicular seams.

At 1002, the specialized equipment provides a bias pattern fabric that extends from a starting side along a run direction. The bias pattern fabric includes carbon fiber threads oriented diagonally relative to the run direction (e.g., at 45 degrees angles to the edges of the bias pattern fabric). In some arrangements, the bias pattern fabric is weaved (or braided) together from a set of carbon fiber threads.

At 1004, the specialized equipment impregnates the bias pattern fabric with resinous material to form a run of prepreg material. As mentioned earlier, a variety of processes are suitable for infusing resin onto the bias pattern fabric (also see FIGS. 6 through 8).

At 1006, the specialized equipment cuts the run of prepreg material lengthwise to the run direction to form multiple tapes. Along these lines, the run of prepreg material may be fed through a blade assembly (also see FIG. 9).

At this point, the multiple tapes are considered carbon composite products themselves. However, such tapes may then be used for form other carbon composite products. For example, such tape may be applied to a tool having a shape of at least a portion of a vehicle or a vehicle component to form a heatshield for the vehicle.

As described above, improved techniques are directed to providing a carbon composite product from a continuous bias pattern fabric 400. Along these lines, such a technique involves creating a long run of bias pattern fabric 400 in which carbon fibers are oriented diagonally (e.g., at a 45° angle) to the run to create a long run of bias prepreg 440. The bias prepreg 440 is then cut in the direction of the run (e.g., continuously sliced) to form long bias tapes 930. Accordingly, such techniques enable production of relatively long runs of bias tape 930 with relative few seams. Moreover, such seams may already be perpendicular to the tape edges resulting in shorter seams, less waste, and better uniformity.

While various embodiments of the present disclosure have been particularly shown and described, it will be understood by those skilled in the art that various changes in form and details may be made therein without departing from the spirit and scope of the present disclosure as defined by the appended claims.

Along these lines, it should be understood that certain embodiments are directed to providing a carbon composite product from a continuous bias pattern fabric. Along these lines, such techniques involve creating significantly long runs of bias pattern fabric to create significantly long runs of bias prepreg. The bias prepreg is then cut in the direction of the run (e.g., continuously sliced) to form long bias tapes. Accordingly, such techniques enable production of long runs of bias tape with relative few seams. Moreover, such seams may be already be perpendicular to the tape edges resulting in shorter seams, less waste, and better uniformity.

One embodiment is directed to a method of providing a carbon composite product. The method involves weaving carbon fiber threads into a bias pattern fabric that extends from a starting side along a run direction, the carbon fiber threads being oriented diagonally relative to the run direction within the bias pattern fabric. The method further involves impregnating the bias pattern fabric with resinous material to form a run of prepreg material. The method further involves cutting the run of prepreg material lengthwise to form multiple tapes.

Another embodiment is directed to a carbon composite product formed by such a method. For example, the carbon composite product may be a supply of bias tape for use in heat shielding applications. As another example, the carbon composite product may be a carbon composite structure formed by deploying the bias tape in a particular manner such as around a conical (or curved) tool in the shape of a reentry vehicle or other hypersonic object.

In some arrangements, weaving carbon fiber threads into the bias pattern fabric includes braiding the carbon fiber threads into a woven material tube, cutting the woven material tube lengthwise to form a material run, and laying the material run flat to provide the bias pattern fabric. Along these lines, carbon fiber thread braiding equipment (e.g., similar to braiding machinery from the textile industry) braids carbon fiber threads to form the woven material tube.

In some arrangements, the run of prepreg material has a first edge and a second edge opposite the first edge. Additionally, cutting the run of prepreg material lengthwise includes passing the run of prepreg material through a set of blades constructed and arranged to cut the run of prepreg material in a direction that is parallel to the first and second edges to form the multiple tapes. Along these lines, the number and widths of the tapes depends on the number of blades and how far the blades are spaced apart from each other to continuously cut the run of prepreg material.

In some arrangements, impregnating the bias pattern fabric with the resinous material includes provisioning the bias pattern fabric with a predefined resin content to form the run of prepreg material. The particular resinous material may be dictated by the particular type of carbon composite material to be formed (e.g., carbon/phenolic, carbon/carbon, and so on).

In some arrangements, provisioning the bias pattern fabric with the predefined content includes placing a set of resin films containing the resinous material in contact with the bias pattern fabric, and applying pressure to the set of resin films to press the resinous material into the bias pattern fabric to form the run of prepreg material. Application of the resinous material may involve running the bias pattern fabric with one or more resin films through and/or around rollers and similar surfaces (e.g., nip rollers, annealing rollers, etc.).

In some arrangements, provisioning the bias pattern fabric with the predefined content includes running the bias pattern fabric through a resin bath, a series of rollers and/or a set of chambers under temperature and humidity control to form the run of prepreg material. Other baths may be included as well (e.g., containing solvents, for rinsing, for cooling/heating, etc.).

In some arrangements, the method further includes, after the bias pattern fabric is provisioned with the predefined resin content, applying a releasable film to the run of prepreg material. Such a releasable film maintains integrity/stability of the prepreg, prevents premature curing, prevents different layers of prepreg from sticking together, and so on.

In some arrangements, the run of prepreg material is seamless for at least 50 feet. Additionally, the method further includes sewing the run of prepreg material to another run of prepreg material to form an aggregate run of prepreg material having a single seam over a length of at least 80 feet. For example, the run of prepreg material may be seamless for 100 linear feet, 200 linear feet, 300 linear feet, etc. Moreover, such sewing may continue to one or more other runs to create an extremely long run of prepreg material with relatively few seams.

In some arrangements, the method further includes rolling the multiple tapes around spools to form bias tape rolls. Examples of such bias tape rolls includes supplies for automated tape layering applications, standard tape wrapping applications, and the like.

In some arrangements, the method further includes unrolling the multiple tapes from the spools onto a set of tools to form a carbon composite structure. Example carbon composite structures include heatshields for hypersonic vehicles, missiles, etc.

Other embodiments are directed to apparatus, devices, and related componentry. Some embodiments are directed to various craft, equipment, tools, systems, sub-systems, methods, and so on, which involve making and/or using a carbon composite product from a continuous bias pattern fabric.

Some embodiments are directed to making and/or using continuous biased fabric prepreg for various applications such as tape wrapping. In accordance with certain embodiments, by manufacturing a fabric that is already ±45° (e.g., through commercial methods), and combining with the same resin(s) used for ablative applications, the material is much more consistent (width, strength/stiffness along the length of the roll), and can be produced much more easily ([the reduced process steps of fabric, prepreg, slit-to-width], vs the incumbent [fabric, prepreg, bias, sew, slit-to-width]. The resultant improved material, using the same or similar constituent materials (fiber, resin), allows for utilization of much more modern processing (while maintaining use in legacy manufacturing methods), and the ability to manufacture parts at 1) a much higher precision, 2) a much higher rate, and 3) and much lower defect rate.

It should be understood that current manufacturing may require manual biasing to achieve a ±45° fabric (cutting standard fabric, with fibers in the 0 and 90 directions (“0/90” configuration) into strips on the 45° bias angle, manually lining them up to sewing/stitching together, and then slit to the proper width), which leads to significant processing issues (defects, lower yield, throughput) when processed. These seams/stiches are a literal weak point in the material, as well as a source of misalignment and width variation.

The current incumbent materials for ablation require the bias/stitch/slit process; other markets utilize carbon fiber with other resins (epoxy) to make a continuous biased fabric, but not for these applications. The combination of these specific input materials, manufacturing technology, and market/application is unique, and we are looking to protect it.

It should be appreciated that certain applications attempt to achieve the following:
A. Correct Width for Application
B. Correct Fiber Volume/Resin Content
C. Continuously Rolled Good under Even Tension
D. ±45 deg Fiber Angle (in relation to rolled material direction)
   The characteristics of the traditional approach are as follows:
1. Weave carbon fabric with traditional loom
   a. Axial fibers (0deg, warp direction)±Transverse fibers (90deg, fill direction)
   b. In: Carbon Fiber
   c. Out: Rolls of 0/90 Carbon Fabric
2. Prepreg carbon fabric with appropriate resin
   a. Various Process
      i. Dip Coating (fabric letoff, dip tank, meter off resin, b-stage/“partial cure”, roll up)
      ii. Film Lamination (make resin film, lay on top/bottom of fabric, heated nip rollers)
   b. In: Carbon Fabric, Resin
   c. Out: Rolls of Carbon/Resin Prepreg
   d. Achieves B
3. Cut Fabric on a bias
   a. In: Prepreg
   b. Out: Sheets (plies) of prepreg, on the ±45 bias
   c. Achieves D
4. Stitch Biased Prepreg Plies End-to-End
   a. In: Sheets of Biased Fabric
   b. Out: Roll, Biased Fabric
   c. Achieves C
5. Slit Bias Fabric into Usable Width
   a. In: Biased Prepreg
   b. Out: Slit Bias Tape
   c. Achieves A
Unfortunately, the traditional approach suffers from the following deficiencies:
   Seaming
      Weak spot in the tape; fails under processing/limits controllability +processability
         If prepreg is 38″ wide, ˜53″ (˜4.5 ft) between seams
         If prepreg is 50″ wide, ˜70″ (5.8 ft) between seams
      Creates defects
      Material that is stitched does not behave the same, under tension, as continuous fabric
   Scrap
      Biasing loses material
      Slitting loses material (trim edge)
      Defects associated with bias/stitching/slitting

In accordance with certain embodiments, the manufacturing path involves the following:

1—Braid a biaxial fabric. Such a process may be similar to that in the textile industry at a commercial level, though there are differences with this input fiber (e.g., carbon fiber threads), the weave architecture (twill vs. satin), the potential need for a small fraction of axial yarns, etc.

2—Prepreg (add resin). This is commercially achievable but not leveraging from the textile industry. Rather, the addition of resin can be done with a variety of ways (solvent dip coating, film impregnation, knife-over-roll coating, etc.), with the end result being a specific amount of resin being added, and thermally treated, to have consistent properties.

3—Slitting. The material is slit down to the proper width, allowing for the precise width control needed for improving downstream processing, as well as to make it suitable for improved/automated manufacturing techniques.

4—Part Manufacture: the material is then utilized in either a tape-wrapping, or automated tape laying (ATL) methodology, in order to wrap shingle-angled parts (common for this market/application). This material could also be used in non-shingled geometries, or for other parts, by selecting a different manufacturing method or different input materials (either the fiber, or the resin).

Based on experience and/or experimentation, the use of legacy material (biased/stitched/slit) resulted in running into issues with nearly every stitch/seam, be it breaking or shifting laterally. Further based on experience and/or experimentation, a small run of new material (100LY) was made, and run through the same process to validate. Such experience and/or experimentation may be augmented via commercial grade equipment (e.g., industrial ATL equipment).

Features of the various improved techniques are as follows:

Starting with: Carbon Fiber Spools
1. Braid ±45 carbon tube, +slit open (in line process)
   a. In: Carbon Fiber
   b. Out: Rolls of ±45deg Carbon Fabric
   c. Achieves C, Achieves D
2. Prepreg carbon fabric with appropriate resin
   a. Various Process
      i. Dip Coating (fabric letoff, dip tank, meter off resin, b-stage/“partial cure”, roll up)
      ii. Film Lamination (make resin film, lay on top/bottom of fabric, heated nip rollers)
   b. In: Carbon Fabric, Resin
   c. Out: Rolls of Carbon/Resin Prepreg
   d. Achieves B
3. Slit Continuous Bias Fabric into Usable Width
   a. In: Biased Prepreg
   b. Out: Slit Bias Tape
   c. Achieves A

Advantageously and in accordance with certain embodiments, the improved techniques involve one or more of the following:
Far fewer steps, far less scrap
Much longer distance between “discontinuities”
   100LY roll of prepreg=300 ft between discontinuity (switch to next prepreg roll)
Uniform processability

Such processes are suitable for impregnating a bias pattern fabric with resinous material to form a run of prepreg material.

As described above and in accordance with certain embodiments, improved techniques are directed to providing a carbon composite product from a continuous bias pattern fabric. Along these lines, such techniques involve creating significantly long runs of bias pattern fabric to create significantly long runs of bias prepreg. The bias prepreg is then cut in the direction of the run (e.g., continuously sliced) to form long bias tapes. Accordingly, such techniques enable production of long runs of bias tape with relative few seams. Moreover, such seams may be already be perpendicular to the tape edges resulting in shorter seams, less waste, and better uniformity.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical.

It should be appreciated that some of the improvements relate generally to the field of strategic materials, processes, and systems. Some improvements relate to heatshields (e.g., a conical carbon/carbon hypersonic heatshield with leading edges and control surfaces) and/or similar objects for hypersonic glide vehicles, cruise missiles, and the like. Additionally, some improvements relate to other methods, apparatus, products, articles of manufacture, etc. such as those for manufacturing brake pads, nozzle covers, and so on.

Furthermore, it should be understood that one example application is a conical carbon/carbon hypersonic heatshield with external features for leading edges and control surfaces. In accordance with certain embodiments, certain improved techniques are suitable for use on hypersonic vehicles with thick-walled heatshields, including strategic boost glide vehicles, tactical boost glide vehicles, and hypersonic cruise missiles. Such improved techniques may also be utilized on maneuvering reentry vehicles.

Along these lines, man-rated reentry vehicles and interplanetary vehicles may utilize products formed by the improved techniques. Other carbon/carbon composite products include brakes, oven fixturing, engine components, nozzles, and nosetips.

Furthermore, it should be understood that additional activities may be included in the above-described processes to control other aspects as well. In accordance with certain embodiments, the processes further include the application of heat (e.g., via a laser, via blown gas, etc.), humidity control, and so on. Moreover, a heatshield may be formed in a controlled amount of time to optimize bonding between layers, curing, cutting, sanding, treating, and so on. Such modifications and enhancements are intended to belong to various embodiments of the disclosure.

What is claimed is:

1. A method of providing a carbon composite product, the method comprising:
providing a bias pattern fabric that extends from a starting side along a run direction, the bias pattern fabric including carbon fiber threads oriented diagonally relative to the run direction;
impregnating the bias pattern fabric with resinous material to form a run of prepreg material; and
cutting the run of prepreg material lengthwise to the run direction to form multiple tapes.

2. The method as in claim 1 wherein providing the bias pattern fabric includes:
weaving a set of carbon fiber threads from a set of carbon fiber thread sources into the bias pattern fabric.

3. The method as in claim 2 wherein weaving the set of carbon fiber threads includes:
braiding the carbon fiber threads from the set of carbon fiber thread sources into a woven material tube,
cutting the woven material tube lengthwise to form a woven material run, and
laying the woven material run flat to provide the bias pattern fabric.

4. The method as in claim 3 wherein braiding the carbon fiber threads includes:
generating a continuous run of woven carbon fiber threads that extends for at least 50 feet.

5. The method as in claim 1 wherein impregnating the bias pattern fabric with resinous material includes:
provisioning the bias pattern fabric with a predefined resin content to form the run of prepreg material.

6. The method as in claim 5 wherein provisioning the bias pattern fabric with the predefined resin content includes:
infusing resin into gaps between the carbon fiber threads and coating resin over the carbon fiber threads.

7. The method as in claim 6 wherein infusing the resin into the gaps between the carbon fiber threads and coating resin over the carbon fiber threads includes:
placing a set of resin films containing the resinous material in contact with the bias pattern fabric, and
applying pressure to the set of resin films to press the resinous material into the bias pattern fabric to form the run of prepreg material.

8. The method as in claim 6 wherein infusing the resin into the gaps between the carbon fiber threads and coating resin over the carbon fiber threads includes:
running the bias pattern fabric through a resin bath, a series of rollers and a set of chambers under temperature and humidity control to form the run of prepreg material.

9. The method as in claim 6 wherein infusing the resin into the gaps between the carbon fiber threads and coating resin over the carbon fiber threads includes:
passing the bias pattern fabric through a knife-over-roll coating process to form the run of prepreg material.

10. The method as in claim 1, further comprising:
after the bias pattern fabric is impregnated with the resinous material to form the run of prepreg material, applying a releasable film onto at least one side of the run of prepreg material to form a laminated prepreg carbon fabric.

11. The method as in claim 10, further comprising:
rolling the laminated prepreg carbon fabric around a set of spools, the releasable film preventing layers of the laminated prepreg carbon fabric from sticking together while the laminated prepreg carbon fabric is rolled around the set of spools.

12. The method as in claim 11 wherein the laminated prepreg carbon fabric has a first edge and a second edge which are parallel to the run direction; and
wherein cutting the run of prepreg material lengthwise includes:
prior to rolling the laminated prepreg carbon fabric around the set of spools, passing the laminated prepreg carbon fabric through a set of blades constructed and arranged to cut the laminated prepreg carbon fabric along a direction that is parallel to the first and second edges to form the multiple tapes.

13. The method as in claim 11 wherein the laminated prepreg carbon fabric has a first edge and a second edge which are parallel to the run direction; and
wherein cutting the run of prepreg material lengthwise includes:
after rolling the laminated prepreg carbon fabric around the set of spools, unrolling the laminated prepreg carbon fabric from the set of spools, and
passing the unrolled laminated prepreg carbon fabric through a set of blades constructed and arranged to cut the unrolled laminated prepreg carbon fabric along a direction that is parallel to the first and second edges to form the multiple tapes.

14. The method as in claim 1, further comprising:
prior to applying the releasable film, sewing the run of prepreg material to another run of prepreg material along a direction that is perpendicular to the run direction to form an aggregate run of prepreg material having a single seam over a length of at least 80 feet.

15. The method as in claim 1, further comprising:
rolling the multiple tapes around spools to form bias tape rolls.

16. The method as in claim 15, further comprising:
unrolling the multiple tapes from the spools, and
placing the unrolled multiple tapes onto a set of tools to form a set of carbon composite structures.

17. The method as in claim 16, further comprising:
prior to placing the unrolled multiple tapes onto the set of tools, sewing a first tape to a second tape along a direction that is perpendicular to the run direction to form an aggregate tape having a single seam over a length of at least 80 feet.

18. The method as in claim 16, further comprising:
prior to placing the unrolled multiple tapes onto the set of tools, removing a releasable film from unrolled multiple tapes, the releasable film having been earlier applied to prevent layers of tape from sticking together.

19. A carbon composite product formed by a method comprising:
providing a bias pattern fabric that extends from a starting side along a run direction, the bias pattern fabric including carbon fiber threads oriented diagonally relative to the run direction;
impregnating the bias pattern fabric with resinous material to form a run of prepreg material; and
cutting the run of prepreg material lengthwise to the run direction to form multiple tapes which are placed onto a set of tools to form at least a portion of the carbon composite product.

20. A vehicle, comprising:
a vehicle body constructed and arranged to carry a payload; and
a carbon composite product coupled with the vehicle body, the carbon composite product being formed by a method comprising:
providing a bias pattern fabric that extends from a starting side along a run direction, the bias pattern fabric including carbon fiber threads oriented diagonally relative to the run direction,
impregnating the bias pattern fabric with resinous material to form a run of prepreg material, and
cutting the run of prepreg material lengthwise to the run direction to form multiple tapes which are placed onto a set of tools to form at least a portion of the carbon composite product.
